(19) United States
(12) Patent Application Publication
(10) Pub. No.: US 2021/0279232 A1
(43) Pub. Date: Sep. 9, 2021

(54) Chatbot Search System, Chatbot Search Method, and Program

(71) Applicant: JE International Corporation, Gifu (JP)

(72) Inventor: Minsu Kim, Nagakute-shi (JP)

(21) Appl. No.: 16/592,896

(22) PCT Filed: Apr. 12, 2019
(86) PCT No.: PCT/JP2019/015983

§ 371 Date: Oct. 4, 2019

(30) Foreign Application Priority Data
Apr. 16, 2018 (JP) 2018-078637

(51) Int. Cl. G06F 16/245; G06N 20/00

(52) U.S. Cl. CPC G06F 16/245; H04L 51/02; G06N 20/00

(57) ABSTRACT

A search system has the following configuration. A chatbot information collection unit collects log information recorded by associating exchange of a text with a terminal device with date and time information from a chatbot server device that provides a chat service by automatically generating a response text and transmitting the response text to the terminal device. An evaluation and measurement unit generates evaluation information of the chatbot server device to write the evaluation information to an evaluation information storage unit on the basis of the evaluation information storage unit configured to store the evaluation information of the chatbot server device and the log information. A search unit reads the evaluation information of the chatbot server device matching a search condition from the evaluation information storage unit and outputs information of the chatbot server device in an order based on the evaluation information.

### TECHNICAL FIELD

The present invention relates to a chatbot search system, a chatbot search method, and a program.

Priority is claimed on Japanese Patent Application No. 2018-078637, filed Apr. 16, 2018, the content of which is incorporated herein by reference.

### BACKGROUND ART

Technology for collecting so-called big data and utilizing the collected big data for various analyses and the like is becoming widespread. Technology for analyzing data using artificial intelligence (AI) is also becoming widespread. Under such circumstances, it is expected that a chat service will be widely provided by means of natural language processing using AI techniques in the future. A chat service using AI is also called an AI chatbot service. In the AI chatbot service, knowledge teaming is performed in advance using a machine learning technique. On the basis of the knowledge, in the AI chatbot service, a text of an appropriate response is output with respect to a chat text transmitted from a user side and the output text is transmitted to a user side. In this manner, the chat service is established by alternately exchanging a text between a terminal device of the user side and a server side (a chatbot server device) The above-described chat service itself using AI can be implemented using existing technology.

For example, Patent Literature 1 describes a chat system that learns a user's preference and automatically generates a posted text using natural language processing.

### CITATION LIST

### Patent Literature

### [Patent Literature 1]

Japanese Unexamined Patent Application, First Publication No. 2017-204157

### SUMMARY OF INVENTION

### Technical Problem

When various business operators and the like provide a large number of AI chatbot services for customers and the like, it becomes difficult for a user to select an optimum service in accordance with a situation. So-called web search engines perform a process of accumulating web documents collected in advance, selecting web pages matching a keyword input by the user in accordance with characteristics thereof, and arranging and outputting the web pages in descending order of degree of expectation of the user. However, these web search engines only determine whether or not details of a static document match the user's request and do not implement a search in a form that particularly matches characteristics of the AI chatbot service. Processing based on the characteristics of the documents is not sufficient to search for an AI chatbot service desired by the user. It is difficult to provide reliable AI chatbot services when AI is not utilized well and conventional web search engines have not analyzed the characteristics of each service in particular.

The present invention has been made on the basis of the problems recognized above. The present invention provides a chatbot search system and its program for searching for an AI chatbot service capable of satisfying a user's purpose and being reliably used by the user.

### Solution to Problem

According to an aspect of the present invention for solving the above-described problems, there is a provided a chatbot search system including: a chatbot information collection unit configured to collect log information recorded by associating exchange of a text with a terminal device in a chatbot server device with date and time information from the chatbot server device that provides a chat service by automatically generating a response text in accordance with a text transmitted from the terminal device of a user and transmitting the response text to the terminal device; a log information storage unit configured to store the log information; an evaluation information storage unit configured to store evaluation information of the chatbot server device; an evaluation and measurement unit configured to generate the evaluation information of the chatbot server device on the basis of the log information and write the evaluation information to the evaluation information storage unit; and a search unit configured to read the evaluation information of the chatbot server device matching a search condition from the evaluation information storage unit on the basis of the search condition that has been input and output information of the chatbot server device in an order based on the evaluation information.

In the above-described chatbot search system, the evaluation and measurement unit may evaluate reliability of the chatbot server device by analyzing a chat text included in the log information and write the reliability as the evaluation information of the chatbot server device to the evaluation information storage unit.

In the above-described chatbot search system, the evaluation and measurement unit may evaluate the reliability by incrementing the number of positive evaluation points and the number of negative evaluation points on the basis of the text and the response text. The evaluation and measurement unit may accumulate a learning shortage response example which is an example of a response sentence in advance when an amount of learning in the chatbot server device is insufficient and increment the number of negative evaluation points in relation to the chatbot server device when the text output by the chatbot server device corresponds to the learning shortage response example.

In the above-described chatbot search system, the evaluation and measurement unit may calculate the number of users per unit time for the chatbot server device on the basis of the log information and write the number of users per unit time as the evaluation information of the chatbot server device to the evaluation information storage unit.

In the above-described chatbot search system, the evaluation and measurement unit may calculate average usage time of the user in the chatbot server device on the basis of the log information and write the average usage time of the user as the evaluation information of the chatbot server device to the evaluation information storage unit.

In the above-described chatbot search system, the chatbot server device may perform a process of performing machine learning based on content data in advance and automatically generating the response text in correspondence with the text transmitted from the terminal device of the user on the basis of a result of the machine learning. The chatbot information collection unit may collect the content data from the chatbot server device. The search unit may select the chatbot server device on the basis of a degree of matching between the content data collected by the chatbot information collection unit and the search condition and output a selection result.

In the above-described chatbot search system, the chatbot server device may hold field information indicating a field of the chat service to be provided. The chatbot information collection unit may collect the field information from the chatbot server device. The search unit may select the chatbot server device on the basis of a degree of matching between the field information collected by the chatbot information collection unit and field information included in the search condition and output a selection result.

The chatbot server device may hold information of a person, information of a shopkeeper, and information of a company for managing the chatbot server device together with the above-described field information. The chatbot server device may hold associated product information and the like related to products and the like handled by the person, the shop, the company, and the like.

The above-described chatbot search system may include a search interface unit configured to receive a search condition extracted from the text by a first chatbot server device from the first chatbot server device when the first chatbot server device provides the chat service to the terminal device, transfer the received search condition to the search unit, receive information of a second chatbot server device corresponding to the search condition from the search unit, and return the information of the second chatbot server device to the first chatbot server device. The search unit may output the information of the second chatbot server device based on the search condition o the search interface unit when the search condition has been transferred from the search interface unit.

In the above-described chatbot search system, the search unit may output the information of the chatbot server device and the information of the second chatbot server device to the search interface unit for the terminal device to simultaneously access both the chatbot server device and the second chatbot server device.

In the above-described chatbot search system, the chatbot information collection unit may collect the log information including information about sales results in the exchange of the text with the terminal device in the chatbot server device as a sales record in association with the date and time information. The evaluation information storage unit may store information obtained by aggregating the sales results based on the sales record as the evaluation information. The evaluation and measurement unit may write the information obtained by aggregating the sales results as the evaluation information to the evaluation information storage unit by performing a process of aggregating the sales results on the basis of the sales record within the log information. The search unit may output the information of the chatbot server device in an order based on the information obtained by aggregating the sales results.

According to an aspect, there is provided a chatbot search method including the steps of: collecting, by a chatbot information collection unit, log information recorded by associating exchange of a text with a terminal device in a chatbot server device with date and time information from the chatbot server device that provides a chat service by automatically generating a response text in accordance with a text transmitted from the terminal device of a user and transmitting the response text to the terminal device; writing the log information to a log information storage unit; generating, by an evaluation and measurement unit, evaluation information of the chatbot server device on the basis of the log information and writing the evaluation information to an evaluation information storage unit; and reading, by a search unit, the evaluation information of the chatbot server device matching a search condition from the evaluation information storage unit on the basis of the search condition that has been input and outputting information of the chatbot server device in an order based on the evaluation information.

Also, according to an aspect, there is provided a program for causing a computer to execute the above-described chatbot search method.

### Advantageous Effects of Invention

According to the present invention, it is possible to provide a user with reliable information of an AI chatbot service. Thereby, the user easily accesses a reliable and easy-to-use AI chatbot service.

### BRIEF DESCRIPTION OF DRAWINGS

FIG. 1 is a schematic block diagram showing a functional configuration of the entire system including a chatbot search system. (First embodiment)

FIG. 2 is a block diagram showing a schematic functional configuration of a chatbot server device. (First embodiment)

FIG. 3 is a block diagram showing a more detailed configuration of an information storage unit of the above-described chatbot server device. (First embodiment)

FIG. 4 is a schematic diagram showing examples of a configuration and data of log information (a log indicating a record of a chat service) held by a log information storage unit. (First embodiment)

FIG. 5 is a schematic diagram showing an example of a configuration and data of field information held by a field information storage unit of the chatbot server device. (First embodiment)

FIG. 6 is a block diagram showing functional configurations of a chatbot information collection device and a storage device. (First embodiment)

FIG. 7 is a schematic diagram showing an example of a configuration of data held by a content storage unit in the chatbot search system. (First embodiment)

FIG. 8 is a schematic diagram showing an example of a configuration of data held by the field information storage unit in the chatbot search system. (First embodiment)

FIG. 9 is a schematic diagram showing an example of a configuration of data held by an evaluation information storage unit in the chatbot search system. (First embodiment)

FIG. 10 is a block diagram showing a schematic functional configuration of a search server device. (First embodiment)

FIG. 11 is a schematic diagram showing details of a process of a search unit in the search server device. (First embodiment)

FIG. 12 is a schematic diagram showing an example of a user interface (a layout of a search screen) at a terminal device side. (First embodiment)

FIG. 13 is a sequence diagram showing an operation procedure of a system (automatic switching of chatbot server device 2) according to a modified example. (First embodiment)

FIG. 14 is a schematic diagram showing an example of a configuration of a sales record included within log information. (Second embodiment)

### DESCRIPTION OF EMBODIMENTS

### First Embodiment

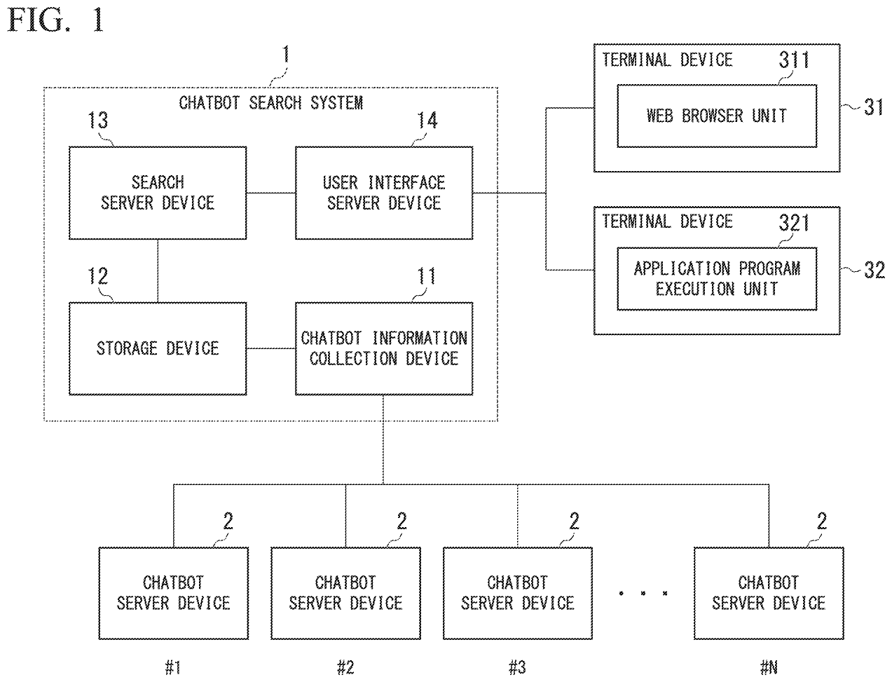

Next, an embodiment of the present invention will be described with reference to the drawings. FIG. 1 is a schematic block diagram showing a functional configuration of the entire system including a chatbot search system according to the present embodiment.

In the following, “AI” is an abbreviation of “artificial intelligence”. Existing technology can be used as the AI itself. The AI can perform learning so that a relationship between input data (text or the like) and output data (text or the like) is appropriate.

A chatbot search system 1 collects information from a large number of chatbot server devices 2. The chatbot search system 1 searches for information of the chatbot server device 2 in response to a request from a terminal device 31 or a terminal device 32 and provides the terminal device 31 or the terminal device 32 with a search result.

There are a plurality of chatbot server devices 2 serving as a search target. In FIG. 1, for convenience, the chatbot server devices 2 are assigned numbers of #1, #2, #3, . . . , #N.

Each chatbot server device 2 provides a chat service to an external terminal device or the like. The AI is installed in the chatbot server device 2 and the AI makes an appropriate chat text response in accordance with a chat text received from the terminal device or the like. Thus, the AI installed in the chatbot server device 2 performs learning in advance using learning data so that it is possible to make an appropriate chat text response. Alternatively, the AI may be configured to perform learning using text data that is input and output in the service while executing a chat service. For example, a deep learning technique can be used as a learning process. By performing such AI learning, the chatbot server device 2 can output a text such as an answer for the user according to the user's intention without individual intervention.

The chatbot server device 2 records traffic information while executing the chat service. Also, the chatbot server device 2 records details of the chat. That is, the chatbot server device 2 records data of a text received by the chatbot server device 2 from an external terminal device or the like and data of a text transmitted by the chatbot server device 2 to the terminal device or the like. Also, the chatbot server device 2 holds information of a field handled by the chatbot server device 2. The field herein is a field of details of a chat performed by the chatbot server device 2. Also, the chatbot server device 2 stores content. This content is data of a large number of documents in the above-described field. The chatbot server device 2 can also perform learning using document data when the above-described learning process is performed. For example, the chatbot server device 2 provides a chatbot information collection device 11 with the above-described traffic information, data of details of the chat, field information, and content in response to a request of the chatbot information collection device 11 of the chatbot search system 1. The chatbot server device is also referred to as an “AI chatbot server device”.

As illustrated, the chatbot search system 1 includes the chatbot information collection device 11, a storage device 12, a search server device 13, and a user interface server device 14. The chatbot information collection device 11 is also referred to as a “chatbot information collection unit”.

The chatbot information collection device 11 collects various types of information for use in searching for a chatbot from the chatbot server device 2 and writes the collected information to the storage device 12. Specifically, the chatbot information collection device 11 collects traffic information in the chatbot server device 2 or information of details of a chat by the chatbot server device 2. Also, the chatbot information collection device 11 collects information of a consultation field of the chatbot server device 2. The chatbot information collection device 11 operates normally and collects the above-described various types of information from the chatbot server device 2 in real time. However, the chatbot information collection device 11 may be configured to collect the above-described various types of information at prescribed. time intervals. Also, the chatbot information collection device 11 measures the evaluation of the chatbot server device 2 on the basis of the information collected from the chatbot server device 2. The chatbot information collection device 11 writes information of a result of evaluating the chatbot server device 2 to the storage device 12. Although details of an evaluation process performed by the chatbot information collection device 11 will be described below, the process includes a process of evaluating the reaction of the user using the chat service on the basis of information of details of the chat.

The chatbot information collection device 11 may be configured to collect and evaluate information from the chatbot server device 2 at one point in time and continuously iterate collection and evaluation of data. The chatbot information collection device 11 may be configured to collect the latest information from the chatbot server device 2 in real time and evaluate the collected information.

That is, the chatbot information collection device 11 automatically generates a response text in accordance with a text transmitted from the terminal device 31 or 32 of the user and transmits the response text to the terminal device 31 or 32. Thereby, the chatbot information collection device 11 collects log information recorded by associating the exchange of a text with the terminal device in the chatbot server device 2 with date and time information from the chatbot server device 2 that provides a chat service.

The storage device 12 stores the information collected by the chatbot information collection device 11. Details of the storage device 12 will be described below.

The search server device 13 executes a search process in response to a search request from the terminal device 31 or 32 while referring to the data stored in the storage device. That is, the search server device 13 reads evaluation information of the chatbot server device 2 matching a search condition from the evaluation information storage unit 123 on the basis of the search condition that has been input. The search server device 13 outputs the information of the chatbot server device 2 in an order based on the evaluation information. Details of the search server device 13 will be described below.

The user interface server device 14 has a function of providing a user interface of the chatbot search system 1 to the terminal device 31 or 32. The user interface server device 14 receives a search condition from the terminal device 31 or 32 via the provided user interface. The user interface server device 14 transfers the search condition to the search server device 13. Also, the user interface server device 14 presents a search result returned from the search server device 13 to the terminal device 31 or 32 of a request source. The user interface server device 14 has functions corresponding to user interfaces for both a web and an application program. That is, the user interface server device 14 performs a process corresponding to the user interface function for the web with respect to a web search request from the terminal device 31. Also, a process corresponding to the user interface function for the application program is performed with respect to a search request from an application program that operates in the terminal device 32.

The chatbot information collection device 11, the search server device 13, and the user interface server device 14 described above are implemented using, for example, an electronic circuit. Also, these devices may be implemented using a computer and a program. Also, the storage device 12 is implemented using a storage means such as, for example, a magnetic disk device or a semiconductor memory.

The terminal device 31 and the terminal device 32 are implemented using, for example, a smartphone, a personal computer (PC), or other information devices. The terminal device 31 or the terminal device 32 transmits the search condition to the chatbot search system 1 and receives a search result as a response thereof from the chatbot search system 1. The search result includes information for accessing the chatbot server device 2. The information for accessing the chatbot server device 2 is, for example, a uniform resource locator. The terminal device 31 or the terminal device 32 can access the chatbot server device 2 indicated by information of the search result and receive a chat service.

The terminal device 31 includes a web browser unit 311. It is possible to use the chatbot search system 1 using a function of a web browser from the terminal device 31.

The terminal device 32 includes an application program execution unit 321. The application program execution unit 321 can cause an application program for accessing the chatbot search system 1 to operate. It is possible to use the chatbot search system 1 using a function of the application program from the terminal device 32.

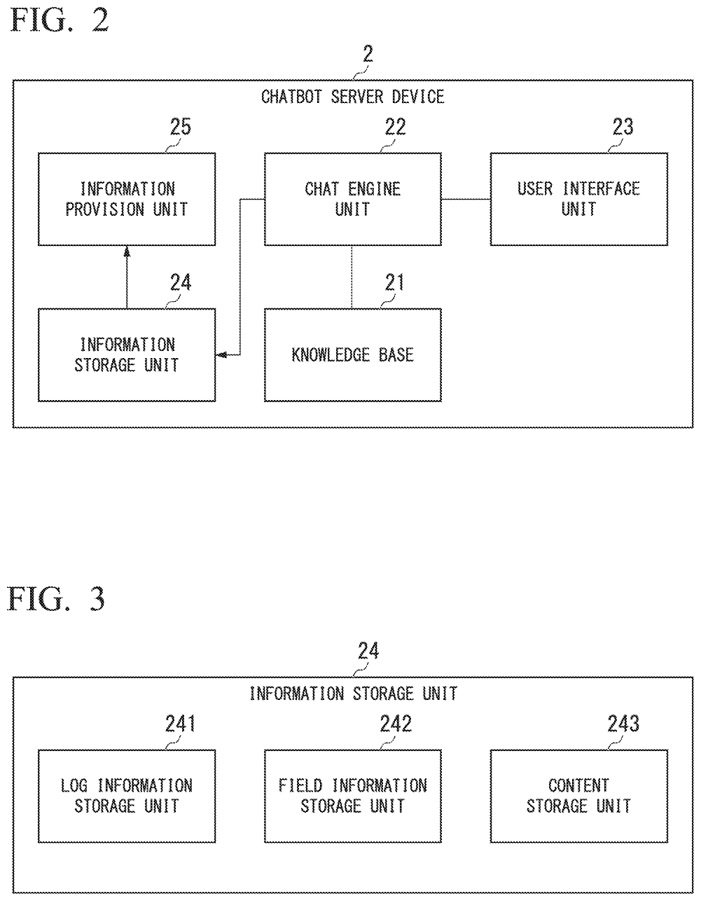

Next, a function of the chatbot server device 2 will be described. FIG. 2 is a block diagram showing a schematic functional configuration of the chatbot server device. As illustrated, the chatbot server device 2 includes a knowledge base 21, a chat engine unit 22, a user interface unit 23, an information storage unit 24, and an information provision unit 25.

The knowledge base 21 stores knowledge data necessary for the chat engine unit 22 to execute a chat process. The knowledge base 21 and the chat engine unit 22 perform a process using AI. The AI itself is implemented using existing technology. Specifically, the knowledge base 21 holds knowledge obtained as a result of a machine learning process of the chat engine unit 22. The machine learning process herein is learning for enabling the chatbot server device 2 to return an optimum response text when a chat text from the terminal device 31 or 32 is received.

The chat engine unit 22 derives the optimum response text with respect to the text received from the terminal device side while referring to the above-described knowledge base 21 and returns the optimum response text to the terminal device side. When a chat service process is executed, the chat engine unit 22 records the progress thereof as log information in the information storage unit 24. Details of the log information will be described below.

The user interface unit 23 has a function of implementing an interface for the terminal device of the user. The user interface unit 23 temporarily receives a text from the terminal device side and transfers the text to the chat engine unit 22. Also, the user interface unit 23 transmits a text output from the chat engine unit 22 to the terminal device side using a prescribed user interface.

The information storage unit 24 stores the above-described log information or other information. The information storage unit 24 is implemented using, for example, a magnetic disk device, a semiconductor memory, or the like. Details of the information storage unit 24 will be described below.

The information provision unit 25 externally provides the information stored by the information storage unit 24. Specifically, the information provision unit 25 provides the chatbot information collection device 11 with the information stored by the information storage unit 24.

FIG. 3 is a block diagram showing a more detailed configuration of the information storage unit 24 described above. As illustrated, the information storage unit 24 includes a log information storage unit 241, a field information storage unit 242, and a content storage unit 243.

The log information storage unit 241 records a log of the chat executed by the chatbot server device 2. Details of the log information will be described below. The log information holds information of a timing (a date and time) when an event occurred, details of the event, and chat details (a text) when the event is transmission and reception of a chat text. The log includes information of the number of users and information of details of a chat.

The field information storage unit 242 stores information of a field targeted by the chat service of the chatbot server device 2.

The content storage unit 243 stores content used by the chatbot server device 2 for the learning process. The content is, for example, a large amount of document data in which knowledge of a type of business targeted by the chat service is described. Using the machine learning technique, the above-described chat engine unit 22 performs learning based on the content thereof in advance.

The data stored by the information storage unit 24 is collected by the chatbot information collection device 11 to be described below. The data is utilized by the chatbot search system 1 to execute a search process.

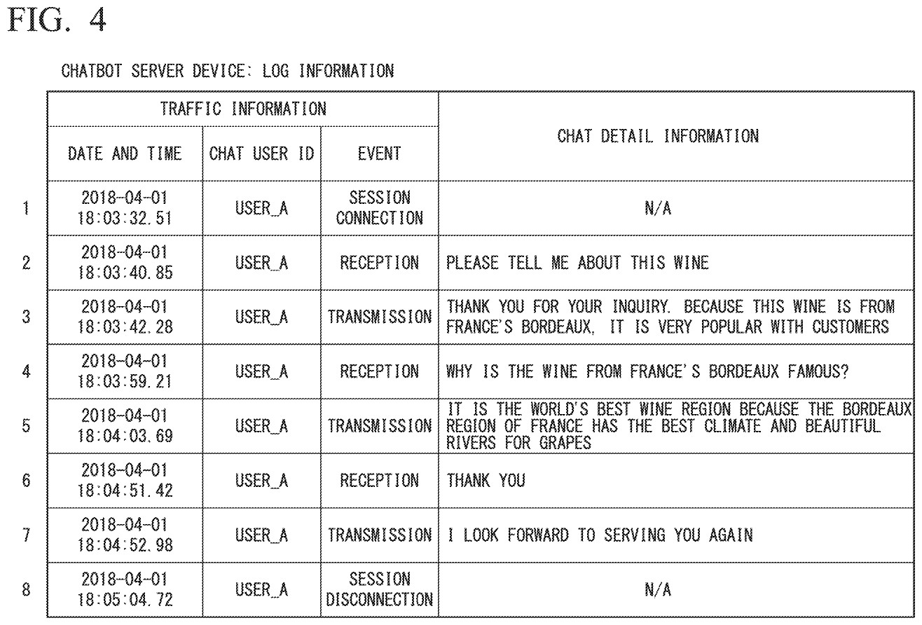

FIG. 4 is a schematic diagram showing examples of a configuration and data of log information held by the log information storage unit 241 described above. As illustrated, the log information is tabular data and has traffic information and chat detail information in association. The traffic information includes items of a date and time, a chat user ID, and an event. The chat detail information includes information of a text exchanged in the chat service. The chat engine unit 22 of the chatbot server device 2 writes log information when the chat service is executed. Data of one row in the log information corresponds to one event in the chat service. Each item of the log information will be described below.

The date and time are a date and time when an event occurred. The chat engine unit 22 acquires date and time information from a clock held by the chatbot server device 2 and records the date and time information as part of the log information. In the illustrated data example, information of year/month/day, hour/minute/second, and hundredths of a second is included as the date and time information.

The chat user ID is information for uniquely identifying a user who receives the chat service. The user is a person who receives the chat service from the chatbot server device 2 using a terminal device or the like.

The event is information indicating a type of event recorded on a corresponding row in the log information. In the illustrated data example, there are four types of events including a session connection, a session disconnection reception, and transmission. The reception indicates that the chatbot server device 2 receives a text from the user. The transmission indicates that the chatbot server device 2 transmits a text to the user.

The chat detail information is details of a text that is received or transmitted by the chatbot server device 2 in the chat service. When the type of event is the session connection or the session disconnection, “N/A” (not applicable) is stored in the chat detail information.

In the illustrated example, chat details are related to a product of alcohol or wine. A row number is assigned to each row of data for convenience. The illustrated data example will be described below with reference to the row number. All first to eighth rows of the illustrated log data are related to the exchange of a text between a user identified by the chat user ID “USER_A” and the chatbot server device 2. The chatbot server device 2 handles a text transmitted from the terminal device and returns a text of a response to the terminal device with reference to the knowledge base.

The first row: The event “session connection” at a date and time “2018-04-01 18:03:32.51” is recorded. Because the first row does not have chat detail information, data “N/A” is recorded.

The second row: The event “reception” at a date and time “2018-04-01 18:03:40.85” is recorded. This represents that the chatbot server device 2 has received the text from the terminal device (a user side). The chat detail information on the second row is “Please tell me about this wine”.

The third row: The event “transmission” at a date and time “2018-04-01 18:03:42.28” is recorded. This represents that the chatbot server device 2 has transmitted a text to the terminal device (the user side). The chat detail information on the third row is “Thank you for your inquiry. Because this wine is from France's Bordeaux, it is very popular with customers”.

The fourth row: The event “reception” at a date and time “2018-04-01 18:03:59.21” is recorded. The chat detail information on the fourth row is “Why is the wine from France's Bordeaux famous?”.

The fifth row: The event “transmission” at a date and time “2018-04-01 18:04:03.69” is recorded. The chat detail information on the fifth row is “It is the world's best wine region because the Bordeaux region of France has the best climate and beautiful rivers for grapes”.

The sixth row: The event “reception” at a date and time “2018-04-01 18:04:51.42” is recorded. The chat detail information on the sixth row is “Thank you”.

The seventh row: The event “transmission” at a date and time “2018-04-01 18:04:52.98” is recorded. The chat detail information on the seventh row is “I look forward to serving you again”.

The eighth row: The event “session disconnection” at a date and time “2018-04-01 18:05:04.72” is recorded. Because the eighth row does not have chat detail information. “N/A” is recorded in a chat detail information field.

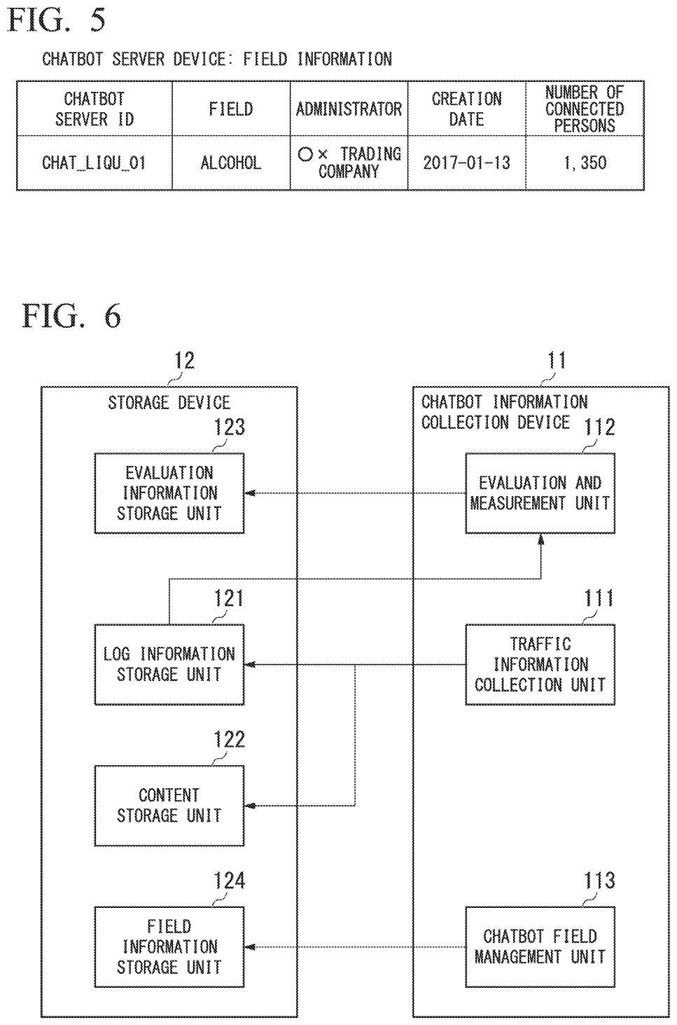

FIG. 5 is a schematic diagram showing examples of a configuration and data of the field information held by the field information storage unit 242. As illustrated, the field information storage unit 242 stores a chatbot server ID for uniquely identifying the chatbot server device 2, information representing a chat field handled by the server device, an administrator, a creation date, and the number of connected users in association with each other. In the illustrated data example, the chatbot server ID is “CHAT_LIQU_01” and a field of a chat handled by the server device is “alcohol”. Also, the administrator is “○× trading company”, the creation date (the start date of the service) is “2017-01-13”, and the number of connected users is “1350”. The creation date described above represents the start date of the service. The above number of connected users is the number of connected users for use of the service per unit time. The unit time is, for example, one hour.

The information storage unit 24 of the chatbot server device 2 may hold information of a person, information of a shopkeeper, and information of a company for managing the chatbot server device 2 together with the above-described field information. Also, the information storage unit 24 may hold associated product information and the like related to products and the like handled by the person, the shop, the company, and the like.

Next, a more detailed functional configuration within the chatbot search system 1 will be described. FIG. 6 is a block diagram showing functional configurations of the chatbot information collection device 11 and the storage device 12.

As illustrated, the chatbot information collection device 11 includes a traffic information collection unit 111, an evaluation and measurement unit 112, and a chatbot field management unit 113. Also, the storage device 12 includes a log information storage unit 121, a content storage unit 122, an evaluation information storage unit 123, and a field information storage unit 124.

The log information storage unit 121 stores log information collected by the chatbot information collection device 11 from the plurality of chatbot server devices 2. A configuration of the log information is as described with reference to FIG. 4.

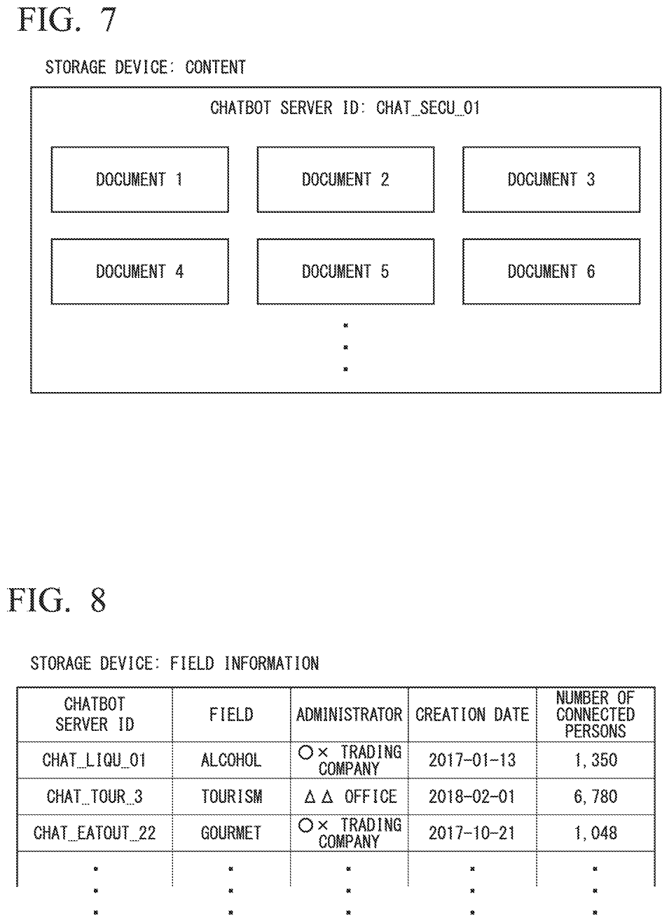

The content storage unit 122 stores content information collected by the chatbot information collection device 11 from the plurality of chatbot server devices 2. The configuration of the content storage unit 122 is shown in FIG. 7.

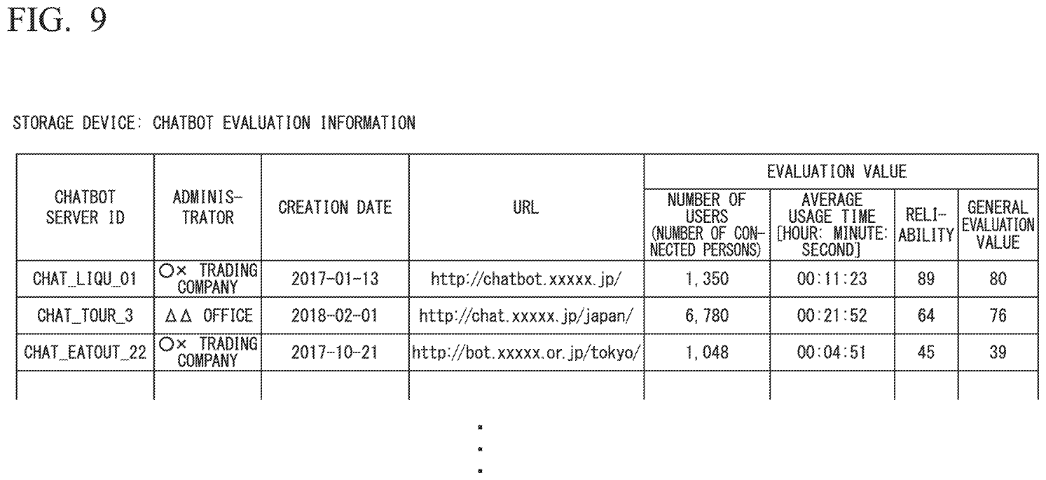

The evaluation information storage unit 123 stores the evaluation information for each chatbot server device 2 determined by the evaluation and measurement unit 112 on the basis of the above-described log information. The configuration of the evaluation information storage unit 123 is shown in FIG. 9.

The field information storage unit 124 stores the field information collected by the chatbot information collection device 11 from the plurality of chatbot server devices 2. The configuration of the field information storage unit 124 is shown in FIG. 8.

The traffic information collection unit 111 acquires traffic information and chat detail information from the chatbot server device 2. The traffic information and the chat detail information are included in the log information provided by the chatbot server device 2. The log information is as described in FIG. 4. The traffic information collection unit 111 writes the acquired log information to the log information storage unit 121 of the storage device 12. Also, the traffic information collection unit 111 acquires content from the chatbot server device 2 and writes the acquired content to the content storage unit 122.

The traffic information is information indicating a degree to which the communication of transmission and reception by the chatbot server device 2 is activated. The activated chat service is used by more users and is highly reliable. In other words, the activated chat service is a chat service with a large amount of traffic. Also, the chat detail information is information indicating the quality of the chat service. A text mainly transmitted from the terminal device of the user side or the like to the chatbot server device 2 side within the chat detail information is used as data for measuring satisfaction and reliability of the user.

The evaluation and measurement unit 112 performs a process of evaluating the chatbot server device 2 on the basis of the log information read from the log information storage unit 121. Specifically, the evaluation and measurement unit 112 analyzes a text of chat details (conversation details), and measures the reliability (the satisfaction) of the user and the like. Then, the evaluation and measurement unit 112 writes information of a result of evaluating the chatbot server device 2 to the evaluation information storage unit 123.

That is, the evaluation and measurement unit 112 generates evaluation information of the chatbot server device 2 and writes the evaluation information to the evaluation information storage unit 123. More specifically, the evaluation and measurement unit 112 evaluates the reliability of the chatbot server device 2 by analyzing the text of the chat included in the log information and writes the above-described reliability as the evaluation information of the chatbot server device 2 to the evaluation information storage unit 123. Details of the process of the evaluation and measurement unit 112 will be described below.

The chatbot field management unit 113 collects information of a field of a service of an AI chatbot executed by the device from the chatbot server device 2. Then, the chatbot field management unit 113 writes the acquired field information to the field information storage unit 124. The field information is information that can be used to present the chatbot server device 2 matching the user's desire as a search result. The above-described user's desire is represented as a search condition or the like.

Details of a process of the evaluation and measurement unit 112 are as follows. As one example, the evaluation and measurement unit 112 evaluates the chatbot server device 2 on the basis of the number of users for each chatbot server device 2, an average usage time of users, and chat detail information (a text).

Here, the number of users is the number of unique users of the chatbot server device 2 per unit time. The evaluation and measurement unit 112 obtains the number of unique users for each time period by analyzing user IDs included in the log information. For example, the evaluation and measurement unit 112 obtains the number of users in units of [persons/hour]. The larger the number of users is, the higher the evaluation of the chatbot server device 2 is.

Also, here, the usage time of the user is a length of time for which one user uses the AI chatbot service. The evaluation and measurement unit 112 can analyze the usage time of the user by referring to the log information storage unit 121. Specifically, the evaluation and measurement unit 112 obtains the usage time of the user by acquiring information of a length from a usage start time to a usage end time of a specific user from the log information storage unit 121. However, even if the user's session is connected, a time period in which the chat text is not exchanged substantially may be excluded from the usage time.

The evaluation and measurement unit 112 obtains usage times of a large number of users and obtains average usage time for each chatbot server device 2. For example, the evaluation and measurement unit 112 obtains the average usage time as a value of “hour: minute: second”. The longer the average usage time of the user is, the higher the evaluation of the chatbot server device 2 is.

Also, the evaluation and measurement unit 112 analyzes chat details included in the log information and obtains the reliability of the chatbot server device 2. Specifically, the evaluation and measurement unit 112 increments each of the number of positive evaluation points and the number of negative evaluation points in the text exchange and determines whether or not the user is satisfied with the chat details, i.e., whether or not the user trusts the chat details.

When the evaluation and measurement unit 112 analyzes the text of the chat details, the number of positive evaluation points and the number of negative evaluation points described above may be incremented on the basis of the type of emoticon or pictogram included in the text.

Here, the number of positive evaluation points is incremented, for example, in the following cases.

1) There is a case in which a positive expression is transmitted from the user (terminal device) side. The positive expression represents gratitude, good feeling, or the like for a hot. The positive expression includes, for example, a term such as “You are smart”, “You know exactly what it is”, or “You are great”. Also, the positive expression includes, for example, an emoticon or a pictogram of an expression such as laughter or admiration. Information representing what is a positive expression is registered in advance in an expression dictionary or the like and referred to.

2) There is a case in which an appropriate answer from the chatbot server device 2 is returned timely in response to a question or the like from the user (terminal device) side.

3) There is a case in which the user (terminal device) side transmits an expression indicating buying a product related to the chat details or using a service. For example, the expression is “Buy (a product)”, “Use (a service)”, “Order”, “Apply”, “Join”, or the like. Also, there is a case in which the user (terminal device) side performs an action of buying a product or using a service in cooperation with the chat details. The cooperation with the above-described chat details is implemented, for example, by a method of following a link leading to an order page or the like.

In contrast, the number of negative evaluation points is incremented, for example, in the following cases.

1) There is a case in which a negative expression (for example, abusing a bot or the like) is transmitted from the user (terminal device) side. For example the negative expression includes a term such as “Not in that sense”, “No, it doesn't mean that”, “Fool”, or “You don't really understand”. Also, the negative expression includes, for example, an emoticon or a pictogram of an expression such as anger, sadness, or tears. Information representing what is a negative expression is registered in advance in an expression dictionary or the like and referred to.

2) There is a case in which there is no appropriate answer from the chatbot server device 2 in response to a question or the like from the user (terminal device) side. For example, there is a case in which the chatbot server device 2 may return an answer such as “I haven't been able to find out enough about your question, sir” in response to the user's question. This is a case in which the chatbot server device 2 cannot sufficiently learn about a field of question details thereof or the like. The evaluation and measurement unit 112 collects and accumulates a response sentence (referred to as a “learning shortage response example”) in advance when an amount of learning is insufficient with respect to the chatbot server device 2 serving as an evaluation target. Then, when the chatbot server device 2 is evaluated, the evaluation and measurement unit 112 determines whether or not an expression similar to the above-described learning shortage response example is included as a response text from the chatbot server device 2 side in the exchange of a text. When the learning shortage response example has been detected, the evaluation and measurement unit 112 increments the number of negative evaluation points for the chatbot server device 2.

The evaluation and measurement unit 112 may be configured to increment the number of negative points based on the learning shortage response example for each chatbot server device 2 in association with the field to which the chat text belongs. That is, when a frequency at which the learning shortage response example occurs in field A is low and a frequency at which the learning shortage response example occurs in field B is high with respect to the chatbot server device 2, the evaluation and measurement unit 112 may be configured to increment the number of negative evaluation points based on the learning shortage response example in association with only field B.

As described here, the evaluation and measurement unit 112 increments each of the number of positive evaluation points and the number of negative evaluation points on the basis of the text from the terminal device side and the response text from the chatbot server device 2 side. Thereby, the evaluation and measurement unit 112 evaluates the reliability. Also, the evaluation and measurement unit 112 accumulates a learning shortage response example which is an example of a response sentence in advance when the amount of learning in the chatbot server device 2 is insufficient and increments the number of negative evaluation points with respect to the chatbot server device 2 when the text output by the chatbot server device 2 corresponds to the learning shortage response The evaluation and measurement unit 112 sums all the positive and negative points as described above for each chatbot server device 2, normalizes a resulting value to a numerical value greater than or equal to 0 and less than or equal to 100, and leaves the numerical value as reliability in evaluation information.

The evaluation and measurement unit 112 generally evaluates the usage time, the number of users, and the reliability described above and outputs a general evaluation value. As an example, the evaluation and measurement unit 112 performs weighted addition of evaluation based on the usage time, evaluation based on the number of users, and the reliability, normalizes a result thereof to a numerical value greater than or equal to 0 and less than or equal to 100, and leaves the numerical value as the general evaluation value in evaluation information.

That is, the evaluation and measurement unit 112 writes the evaluation results listed above to the evaluation information storage unit 123. An example of a configuration of the evaluation information storage unit 123 will be described below.

That is, the evaluation and measurement unit 112 has the following characteristics. The evaluation and measurement unit 112 calculates the number of users per unit time of the chatbot server device 2 on the basis of the log information. The evaluation and measurement unit 112 writes the number of users per unit time as evaluation information of the chatbot server device 2 to the evaluation information storage unit 123.

The evaluation and measurement unit 123 calculates the average usage time of the user in the chatbot server device 2 on the basis of the log information and writes the average usage time of the user as evaluation information of the chatbot server device 2 to the evaluation information storage unit 123.

Next, a more detailed data configuration of each unit included in the storage device 12 will be described. FIG. 7 is a schematic diagram showing an example of a configuration of data held by the content storage unit 122. As illustrated, the content storage unit 122 stores data of content related to the corresponding chatbot server device 2 in association a chatbot server ID. Here, content data is a plurality of pieces of document data. The document data is, for example, data such as a document of a hyper-text markup language (HTML) format or a document of a portable document format (PDF) format. In the illustrated example, the content storage unit 122 stores content data such as document 1, document 2, document 3, document 4, document 5, document 6, and the like in association with the chatbot server ID “CHAT_SECU_01”, Details learned by the chatbot server device 2 are represented.

Although FIG. 7 shows only data related to one type of chatbot server ID, the content storage unit 122 may hold content data related to two or more types of chatbot server IDs.

FIG. 8 is a schematic diagram showing an example of a configuration of data held by the field information storage unit 124. As illustrated, the field information storage unit 124 is tabular data and includes data items of a chatbot server ID, a field, an administrator, and the number of connected persons. Each row of the table stored by the field information storage unit 124 corresponds to one chatbot server device 2. In the illustrated data example, fields of “alcohol”, “tourism”, “gourmet”, and the like correspond to chatbot server IDs “CHAT_LIQU_01”, “CHAT_TOUR_3”, “CHAT_EATOUT_22”, and the like. Also, administrators are “○× trading company”, “ΔΔoffice”, “○× trading company”, and the like. Creation dates are “2017-01-13”, “2018-02-01”, “2017-10-21”, and the like. Also, the number of connected persons is “1350”, “6780”, “1048”, and the like. That is, the field information storage unit 124 collectively holds field information collected by the chatbot information collection device 11 from the plurality of chatbot server devices 2.

FIG. 9 is a schematic diagram showing an example of a configuration of data held by the evaluation information storage unit 123. As illustrated, the evaluation information storage unit 123 stores tabular data. A table stored by the evaluation information storage unit 123 includes data items of a chatbot server ID, an administrator, a creation date, a URL, and an evaluation value. The item of the evaluation value further includes items such as the number of users (the number of connected users), average usage time, reliability, and a general evaluation value. The evaluation value may include further other data items. Each row of the table corresponds to one chatbot server device 2. The meaning of each data item is as follows.

The chatbot server ID is identification information for uniquely identifying the chatbot server device 2.

The administrator is an entity that manages and operates the chatbot server device 2. The entity that operates the chatbot server device 2 is a corporation or the like.

The creation date is a date when the chatbot server device 2 started the service.

The is location information for accessing the chat service of the chatbot server device 2.

The number of users (the number of connected users) is the number of users who use the chat service of the chatbot server device 2 per unit time. The number of users is represented in units of persons per hour (persons/hour).

The average usage time is an average value in a length of time from the start of use of the chat service to the end of use by one user. The average usage time is represented as a value in the form of “hour:minute:second”.

The reliability is reliability for a service provided by the chatbot server device 2. A method of obtaining the reliability and the like are as described above. Here, the reliability is represented as a numerical value greater than or equal to 0 and less than or equal to 100. The larger the numerical value is, the higher the reliability is.

The general evaluation value is a value of general evaluation based on the number of users, the average usage time, or the reliability described above or the like. Here, the general evaluation value is represented as a numerical value greater than or equal to 0 and less than or equal to 100. The larger the numerical value is, the higher the evaluation is.

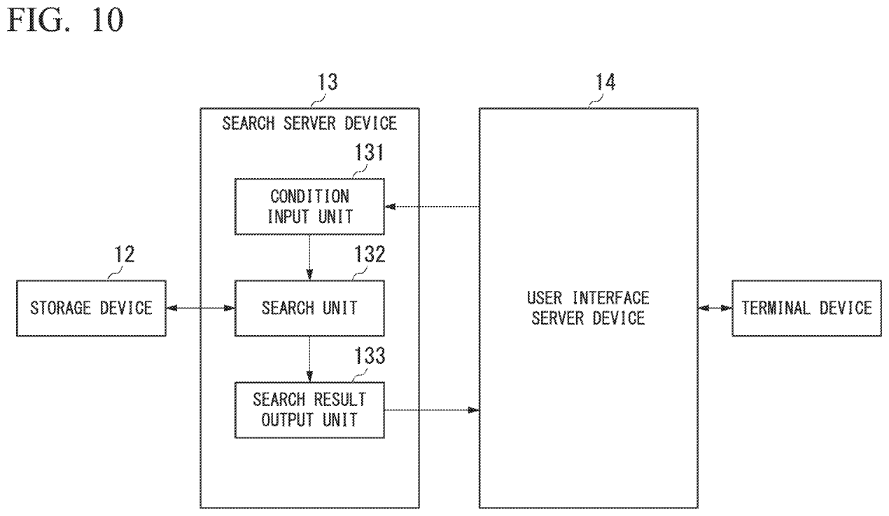

Next, the more detailed configuration and process of the search server device 13 will be described. FIG. 10 is a block diagram showing a schematic functional configuration of the search server device. As illustrated, the search server device 13 includes a condition input unit 131, a search unit 132, and a search result output unit 133.

The condition input unit 131 acquires a search condition for searching for a chatbot server device from the user interface server device 14 side. The search condition is transmitted from the terminal device. The condition input unit 131 transfers the search condition to the search unit 132.

The search unit 132 refers to data stored in the storage device 12 on the basis of the transferred search condition and selects information of the AI chatbot service that meets the search condition. Information of the service includes access information (a URL or the like) for the corresponding chatbot server device 2. Details of a detailed process of the search unit 132 will he described below.

The search result output unit 133 outputs a search result transferred from the search unit 132. Specifically, the search result output unit 133 transfers the search result to the user interface server device 14. Thereby, the user interface server device 14 can return the search result to the terminal device side using a prescribed user interface. The search result output unit 133 outputs information about one or more chatbot server devices 2 as the search result. Because the information of the search result includes the access information for the corresponding chatbot server device 2, the terminal device receiving the search result can access the chatbot server device 2 and receive a provided chat service.

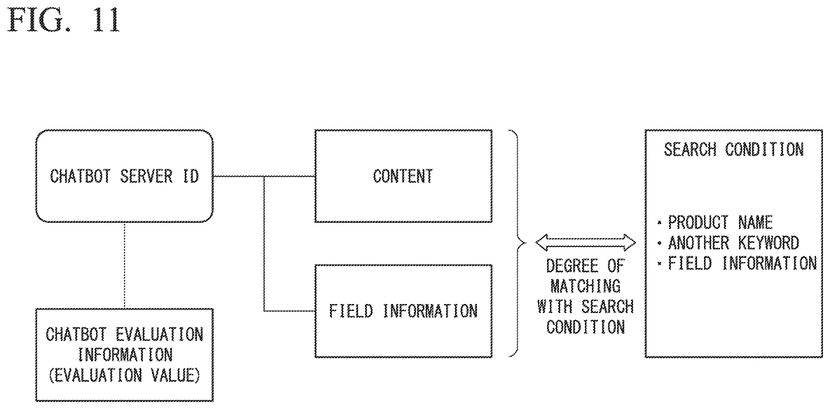

Here, details of a process of the search unit 132 will be described. FIG. 11 is a schematic diagram showing details of the process of the search unit 132.

The search condition received by the search unit 132 includes field information and any keyword. The field information is information representing a field of a chat service provided by the chatbot server device 2. The keyword is any string or the like. The keyword transferred as the search condition may be a single word, a list of a plurality of words, a sentence, or a fragment of a sentence. Also, a keyword of a product name may be included as a special keyword.

The search unit 132 performs a search process on the basis of the search condition represented by the field information and the keyword. Specifically, the search unit 132 calculates a degree of matching between the received search condition and the content storage unit 122 and the field information storage unit 124 stored in the storage device. This search condition is a condition related to a product name, another keyword, field information, information of an administrator (a person, a shopkeeper, a company, or the like), a region name, or the like. At this time, the search unit 132 calculates, for example, a degree of matching between the product name and another keyword included in the search condition and a text of the content included in the content storage unit 122. Also, the search unit 132 calculates the degree of matching between the field information included in the search condition and the field information stored by the field information storage unit 124. The calculation of the degree of matching here can be performed using the existing technology. For example, the search unit 132 can calculate a degree of matching between a keyword and a text of content using cosine similarity of an appearing word vector. Also, the search unit 132 can calculate a degree of matching of the field information using a distance between nodes in a field tree defined in advance or the like. The above-described field tree is a graph in which a large number of nodes corresponding to the field are connected on the tree. As shown in FIG. 7, content (document 1, document 2, or the like) including a text is associated with the chatbot server ID in the content storage unit 122. Also, as shown in FIG. 8, the field information is associated with the chatbot server ID in the field information storage unit 124. That is, the search unit 132 can calculate the degree of matching for each chatbot server ID with respect to the keyword included in the search condition. Also, the search unit 132 can calculate the degree of matching for each chatbot server ID with respect to the field information included in the search condition. The search unit 132 may calculate an integrated degree of matching by weight-adding the two types of degrees of matching (the degree of matching in the keyword and the degree of matching in the field information) listed here. Thereby, the search unit 132 can obtain the degree of matching corresponding to the transferred search condition for each chatbot server ID. In other words, the search unit 132 can determine the order of chatbot server IDs in correspondence with the transferred search condition.

Also, the search unit 132 refers to the evaluation information storage unit 123 shown in FIG. 9. That is, the search unit 132 can read the reliability, the general evaluation value, or both thereof for each chatbot server ID from the evaluation information storage unit 123.

That is, when a search condition has been assigned, the search unit 132 acquires information of the degree of matching obtained by referring to the content storage unit 122 or the field information storage unit 124 and the reliability or the general evaluation value obtained by referring to the evaluation information storage unit 123 for each chatbot server ID. The search unit 132 can output the order of chatbot server IDs corresponding to the search condition by adding both thereof (for example, calculating a weighted sum of scores). At this time, information of the calculated score may be added to each chatbot server ID.

Alternatively, the search unit 132 may narrow down the chatbot server IDs according to the degree of matching obtained by referring to the content storage unit 122 or the field information storage unit 124 and determine the order of the chatbot server IDs. This order is obtained by the general evaluation value and the like stored by the evaluation information storage unit 123.

The search unit 132 outputs information of a chatbot server ID matching the search condition and the order thereof as a search result. As shown in FIG. 9, the evaluation information storage unit 123 holds access information (a URL or the like) for accessing the chat service in the server device in association with the chatbot server ID. Therefore, the search unit 132 can also output access information for the chatbot server device 2 matching the search condition. For example, the search unit 132 arranges and outputs information of a plurality of chatbot server devices 2 in descending order of an evaluation value.

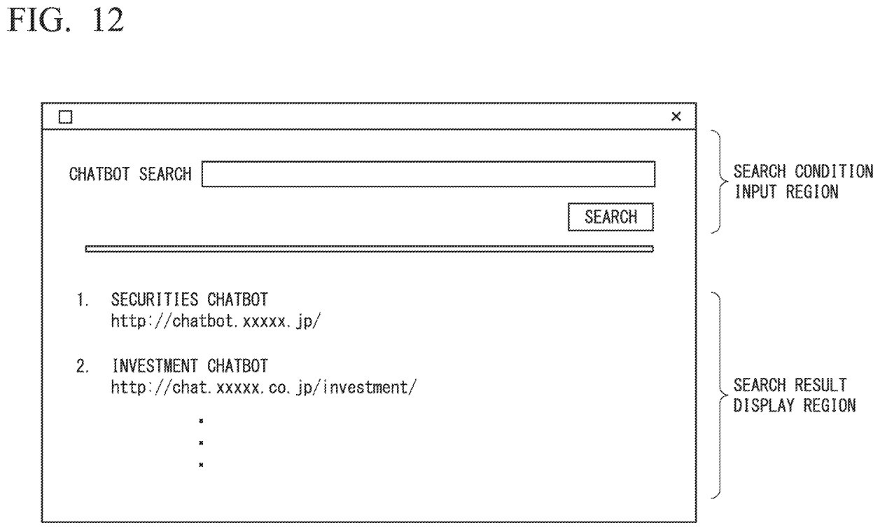

FIG. 12 is a schematic diagram showing an example of a user interface (a screen layout) at the terminal device side. As illustrated, the screen has a search condition input region and a search result display region. The search condition input region is provided with fields to which search conditions (for example, a product name, another keyword, a field, and the like) can be freely input. Also, a search button is provided in the search condition input region and data input to each field may be transmitted to the user interface server device 14 side when the user clicks the button or performs an operation such as a tap. Also, search results can be displayed in the search result display region. In this example, order information (a numerical value indicating an order such as 1, 2, or the like), a chat service name (for example, a “securities chatbot” or the like), and its URL (for example, “http://chatbot.xxxxx.jp” or the like) are displayed as the search results.

Other information may be further displayed. Information displayed in the search result display region (a name or a URL of a chat service) can be selected by the user's operation (a click, a tap, or the like). When information displayed as the search result (information of the chatbot server device 2) is selected by the user, the terminal device accesses the chatbot server device 2 through communication. In this manner, the terminal device can access any chat service within the search results.

In the present embodiment, the chatbot server device 2 performs a process of performing machine learning based on content data in advance and automatically generating the above-described response text in correspondence with the text transmitted from the terminal device of the user on the basis of a result of the machine learning. The chatbot information collection device 11 collects the above-described content data from the chatbot server device 2. The search server device 13 selects the chatbot server device 2 on the basis of a degree of matching between the content data collected by the chatbot information collection device 11 and the search condition and outputs a selection result.

The chatbot server device 2 holds field information representing the field of the chat service to be provided. The chatbot information collection device 11 collects the above-described field information from the chatbot server device 2;

The search server device 13 selects the chatbot server device 2 on the basis of a degree of matching between the above-described field information collected by the chatbot information collection device 11 and the field information included in the above-described search condition and outputs a selection result.

Also, at least some functions of devices such as the chatbot server device, the chatbot information collection device, the search server device, the user interface server device, and the terminal device in the above-described embodiments can be implemented by a computer. In this case, the functions may be implemented by recording a program for implementing the functions on a computer-readable recording medium and causing a computer system to read and execute the program recorded on the recording medium. Also, the “computer system” described here is assumed to include an operating system (OS) and hardware such as peripheral devices. Also, the “computer-readable recording medium” refers to a storage device including a flexible disk, a magneto-optical disc, a read only memory (ROM), a compact disc (CD)-ROM, a digital versatile disc (DVD)-ROM, a portable medium such as a universal serial bus (USB) memory, and a hard disk embedded in the computer system. Further, the “computer-readable recording medium” may include a computer-readable recording medium for temporarily dynamically holding a program as in a communication line when the program is transmitted via a network such as the Internet or a communication circuit such as a telephone circuit and a computer-readable recording medium for holding the program for a fixed time as in a volatile memory inside the computer system including a server and a client when the program is transmitted. The above-described program may be used to implement some of the above-described functions. Further, the program may implement the above-described functions in combination with a program already recorded on the computer system.

Hereinafter, modified examples of the embodiment will be described.

### First Modified Example

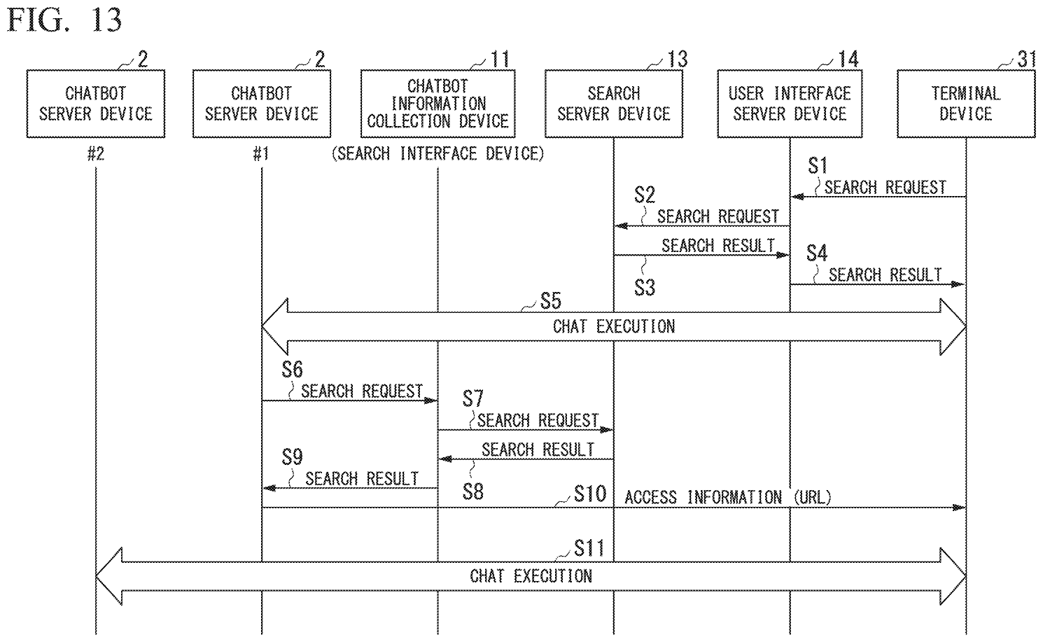

FIG. 13 is a sequence diagram showing an operation procedure of a modified example of the system shown in FIG. 1. In the present modified example, the switching of a service for another chatbot server device 2 is implemented while a chat is executed between the terminal device 31 (which may be the terminal device 32. The same is true hereinafter) and the chatbot server device 2 on the basis of search results. Thereby, the single chatbot server device 2 performs the service and it is possible to automatically perform switching to the chatbot server device 2 which is more appropriate in accordance with chat details. Moreover, the switching is performed seamlessly without requiring the time and effort of the user.

Hereinafter, a procedure will be described below in accordance with the sequence shown in FIG. 13.

First, in step S1, the terminal device 31 transfers a search condition to the user interface server device 14 and requests searching for the chatbot server device 2.

Next, in step S2, the user interface server device 14 transfers the search condition transferred from the terminal device 31 to the search server device 13 and requests the searching for the chatbot server device 2.

Next, in step S3, the search server device 13 performs a search process in accordance with the transferred search condition and transfers the obtained search result to the user interface server device 14.

Next, in step S4, the user interface server device 14 returns a search result transferred from the search server device 13 to the terminal device 31. As described above, the search result includes access information (a URL and the like) for the chatbot server device 2. Thereby, the terminal device 31 side can select an appropriate chatbot server device 2 from among the search results and access the selected chatbot server device 2.

Next, in step S5, the terminal device 31 accesses a desired chatbot server device 2 (#1) on the basis of the obtained search result. Then, a chat is executed between the terminal device 31 and the chatbot server device 2 (#1).

In this chat, it may be determined that a process in which another chat server device 2 provides a service on the basis of text details transmitted from the terminal device 31 to the chatbot server device 2 (#1) is appropriate. In this case, the chatbot server device 2 (#1) requests the search server device 13 to perform a search via the chatbot information collection device 11 so that an appropriate chatbot server device 2 is searched for. That is, this process is as follows.

In step S6, the chatbot server device 2 (#1) transfers a search condition to the chatbot information collection device 11. The search condition includes a keyword or the like. Here, the chatbot information collection device 11 functions as a search interface device (a search interface unit). That is, the chatbot information collection device 11 provides the chatbot server device 2 (#1) with a function of an interface for the search process of the search server device 13.

Next, in step S7, the chatbot information collection device 11 requests the search by transferring the search condition transferred from the chatbot server device 2 (#1) to the search server device 13.

Next, in step S8, the search server device 13 performs a search process according to the transferred search condition and transfers an obtained search result to the chatbot information collection device 11.

Next, in step S9, the chatbot information collection device 11 returns the search result transferred from the search server device 13 to the chatbot server device 2 (#1).

Next, in step S10, the chatbot server device 2 (#1) returns the search result to the terminal device 31. Here, the search result also includes access information for the chatbot server device 2. For example, the search result includes access information for another chatbot server device 2 (#2) different from the chatbot server device 2 (#1). Also, at this time, control information for instructing the terminal device 31 to automatically access the chatbot server device 2 (#2) using the access information may be included.

Next, in step S11, the terminal device 31 accesses the chatbot server device 2 (#2) on the basis of the obtained search result. Thereby, the chat is executed between the terminal device 31 and the chatbot server device 2 (#2).

According to the above-described processing procedure, the terminal device 31 receiving the chat service from the chatbot server device 2 (#1) automatically switches an access destination thereof. That is, the terminal device 31 smoothly transitions to a state in which a chat service is received from the chatbot server device 2 (#2).

An example of a use case to which this modified example is applied is as follows. First, the terminal device 31 requests searching for the chatbot server device 2 to obtain information about “lunch box”. This process corresponds to step S1 of FIG. 13. Thereby, the terminal device 31 executes a chat with the chatbot server device 2 (#1). Thereby, the terminal device 31 obtains information about the lunch box. A case in which it is desired to obtain information about another product or the like in relation to details of the lunch box in the chat regarding the lunch box may occur. For example, when the user desires to obtain information of soup in relation to the lunch box, a text reflecting the desire is transmitted from the terminal device 31 side. For example, a text such as “what is soup?” is transmitted from the terminal device 31 to the chatbot server device 2 (#1). At this time, the chatbot server device 2 (#1) recognizes that the knowledge of the soup possessed by the local device is poor, i.e., an amount of learning is relatively small, and determines that it is better to take over a chat service to another chatbot server device 2. As a result, the chatbot server device 2 (#1) transmits a search request for the “soup” to the chatbot information collection device 11. This process corresponds to step S6 in FIG. 13. As a result, the terminal device 31 seamlessly transitions to the chat with the chatbot server device 2 (#2) through the procedure described above.

That is, the present modified example is as follows. The chatbot information collection device 11 (functioning as a search interface unit) receives a search condition extracted from the text by the first chatbot server device 2 from the first chatbot server device when the first chatbot server device 2 provides the above-described chat service to the terminal device 31 or 32. The chatbot information collection device 11 transfers the received search condition to the search server device 13 and receives information of the second chatbot server device 2 corresponding to the search condition from the search server device 13. The chatbot information collection device 11 returns the information of the second chatbot server device to the first chatbot server device 2 (#1). When the search condition has been transferred from the chatbot information collection device 11 (the search interface unit), the search server device 13 outputs information of the second chatbot server device 2 (#2) based on the search condition to the chatbot information collection device 11 (the search interface unit).

According to the present modified example, the search server device 13 can perform the search process on the basis of the search condition or the like input by the user and the chatbot server device 2 can cause the search server device 13 to perform the search process on the basis of a search condition picked up from the chat text. Thereby, a plurality of chatbot server devices 2 can dynamically cooperate with each other and provide the terminal device with various chat services utilizing characteristics of each chatbot server device 2.

Furthermore, a modified example obtained by further modifying the first modified example shown in FIG. 13 may be executed.

### Second Modified Example

In the second modified example, for example, even after the chatbot server device 2 (#1) receives the search result in step S9 of FIG. 13, the chatbot server device 2 (#1) may continuously perform a process of a chat with the terminal device 31. Also, after the chatbot server device 2 (#1) receives the search result in step S9, a plurality of chatbot server devices 2 (#1 and #2) may be configured to perform a process of a chat with the terminal device 31 in parallel. Thereby, each of the plurality of chatbot server devices 2 (#1 and #2) can provide the terminal device 31 with a chat service related to its own specialized topic (knowledge and learning result).

Furthermore, the second modified example described above may be performed instead of the third modified example as follows.

### Third Modified Example

In the third modified example, after the chatbot server device 2 (#1) receives a search result in step S9 of FIG. 13, the chatbot server device 2 (#1) inquires of the terminal device 31 about the acceptance or rejection of a connection to a new chat service. That is, for example, at this time, the chatbot server device 2 (#1) inquires of the terminal device 31 about whether or not the chat service from the chatbot server device 2 (#2) may be connected. On the other hand, the terminal device 31 returns acceptance/rejection information to the chatbot server device 2 (#1). The acceptance/rejection information is information representing either “Yes” or “No”.

The chatbot server device 2 (111) transfers the access information (URL) of step S10 to the terminal device 31 only when the acceptance/rejection information corresponding to “Yes” is returned from the terminal device 31. Thereby, the terminal device 31 can also be connected to the chatbot server device 2 (#2) together with the chatbot server device 2 (#1) and can perform a chat with both parties.

Also, when the acceptance/rejection information corresponding to “No” has been returned front the terminal device 31, the chatbot server device 2 (#1) does not transfer the access information (URL) of step S10 to the terminal device 31. In this case, the terminal device 31 is not connected to the chatbot server device 2 (#2) and continues to chat with only the chatbot server device 2 (#1).

A specific application example of the third modified example is as follows. In the present example, the chatbot server device 2 (#1) provides a chat service related to sushi. Also, the chatbot server device 2 (#2) provides a chat service related to miso soup.

The user of the terminal device 31 operates the terminal device 31 while eating sushi at a sushi shop and receives the chat service related to the sushi from the chatbot server device 2 (#1) (corresponding to step S5 of FIG. 13).

Here, the miso soup is mentioned as details of the chat (in step S5). For example, a text of a question related to the miso soup is transmitted from the terminal device 31 to the chatbot server device 2 (#1).

The chatbot server device 2 (#1) recognizes that the local device does not have abundant knowledge of the miso soup, accesses the search server device 13, and obtains information of the chatbot server device 2 (#2) that is another device as a search result (the processing of a series of steps S6, S7, S8, and S9). Also, the chatbot server device 2 (#2) is a device that provides the chat service related to the miso soup.

The chatbot server device 2 (#1) transmits, for example, a question “Can I introduce you to a miso soup chatbot?” to the terminal device 31, and waits for acceptance/rejection information to be received from the terminal device 31 (processing between steps S9 and S10).

When the terminal device 31 transmits a response corresponding to “Yes”, the chatbot server device (#1) transmits access information for the chatbot server device 2 (#2) (step S10). Thereby, the terminal device 31 can receive the chat service from the chatbot server device

When the terminal device 31 transmits a response corresponding to “No”, the chatbot server device 2 (#1) does not transmit access information for the chatbot server device 2 (#2) (not shown). In this case, the terminal device 31 cannot be connected to the chatbot server device 2 (#2).

### Fourth Modified Example

The fourth modified example is a further variation of the first modified example, the second modified example, and the third modified example described above.

In a fourth modified example, the search unit 132 outputs information of the chatbot server device 2 (#1) and information of the chatbot server device 2 (#2) to the search interface unit so that the terminal device simultaneously accesses both the chatbot server device 2 (#1) and the chatbot server device 2 (#2). Thereby, the terminal device can simultaneously receive chat services from the two chatbot server devices 2 in parallel.

### Second Embodiment

Next, a second embodiment will be described. Also, a configuration and a processing procedure assumed by the present embodiment are as shown FIGS. 1 to 13 in the first embodiment. Description of matters already described by the above embodiment may be omitted. Here, matters specific to the present embodiment will he mainly described.

The present embodiment is characterized in that an operator side of the chatbot server device 2 may sell a product, a service, or the like (hereinafter collectively referred to as a “product or the like”) to an end user side in the chat service provided by the chatbot server device 2. The users of the sales destinations are the users of the terminal devices 31 and 32. Here, the above-described “operator side” also includes a business operator who entrusts the operation of the computer system to the operator and a business operator who uses a service provided by the operator in a position of a franchisee or the like. That is, when a chat is performed on the basis of the knowledge base 21, the chat engine unit 22 of the chatbot server device searches for an opportunity to sell a product or the like within a text transmitted from the terminal device side. Also, the chat engine unit 22 transmits a text for appealing the attractiveness of a product or the like to the terminal device. Also, the chat engine unit 22 discovers an opportunity from the exchange of a text in the chat and transmits a text for prompting an end user to order a product or the like to the terminal device. Then, the chat engine unit 22 receives a text for ordering a product or the like from the terminal device side. Thereby, the chat engine unit 22 causes an order for a product or the like from the user of the terminal device side to be completed. A series of exchanges in a chat are implemented by means of the knowledge base 21 in which learning is completed in advance.

When a product or the like is sold, the chat engine unit 21 writes details of the order received for the product or the like as a sales record within the log information to the log information storage unit 241 of the information storage unit 24.

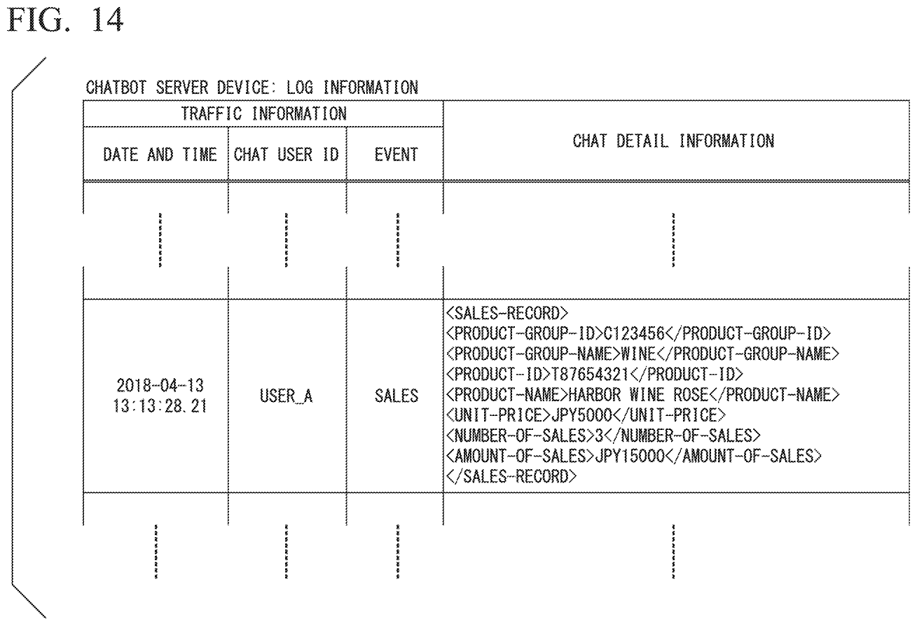

FIG. 14 is a schematic diagram showing an example of a configuration of a sales record included within log information. As illustrated, item names themselves of the log information are similar to those shown in FIG. 4 of the first embodiment. In the sales record, an item of an event within traffic information is recorded as “sales”. Also, information of types of sold products, the number of sold products, and an amount of money of sold products is recorded in the item of chat detail information. In the illustrated example, information of items of a product group ID, a product group name, a product ID, a product name, a unit price, the number of sales, and an amount of sales is recorded within the sales record using tag information. In the illustrated data example, a record in which wine whose product group ID is “C123456” and whose product ID is “T87654321” is sold is shown. Also, in this data, the unit price of the product is “JPY5000” (5000 yen), the number of sales is “3”, and the amount of sales is “JPY15000” (15000 yen).

As described above, the chatbot information collection device 11 collects information including log information from the chatbot server device 2. That is, e information including the sales record described above is also written to the log information storage unit 121 of the storage device 12.

In the present embodiment, the evaluation and measurement unit 112 aggregates and analyzes sales records included in the log information storage unit 121. Thereby, the evaluation and measurement unit 112 generates multi-dimensional product sales aggregation data. The multi-dimensional product sales aggregation data holds numerical data of the number of sales and an amount of sales on the axis for each product group ID, each product ID, each chatbot server ID, or each period. The period may have, for example, a hierarchy of a year-month-day-time period, a hierarchy of a year-week-day-time period, or the like. The multi-dimensional product sales aggregation data can be implemented, for example, by storing the data in a multi-dimensional database, a relational database or a multimedia database, which is existing technology.

When a search condition related to a product or the like is received from the terminal device side, the search server device 13 searches for the above-described multi-dimensional product sales aggregation data on the basis of information such as a product ID, a product name, a product group ID, or a product group name included within the search condition. Thereby, the search server device 13 can rank chatbot server IDs with respect to one or more specific product group IDs or product IDs. The ranking of the chatbot server IDs is equivalent to the ranking of business operators (shops). Here, the ranking is the ranking in descending order of the number of sales or an amount of sales. Also, when the ranking is performed, a period to which a sales record belongs may be narrowed down.

Also, the search server device 13 may be configured to rank chatbot server IDs in order from the earliest sales date and time with respect to one or more specific product group IDs or product IDs on the basis of the above-described log information.

As described above, the search server device 13 can rank the chatbot server IDs with respect to a prescribed product or the like on the basis of a sales record within the log information or on the basis of a result of aggregating sales records and return a search result according to the ranking to a terminal device of a search request source. Consequently, at the terminal device side, it is possible to obtain and display access information for the chatbot server device 2 in descending order of the number of sales or an amount of sales as a result of searching for a prescribed product or the like. That is, the chatbot server device 2 with an excellent sales result is ranked higher in the search results and displayed on the terminal device side according to the ranking.

Summarizing the above, the chatbot search system according to the present embodiment is as follows. The chatbot information collection device 11 collects log information including information about sales results in the text exchange with the terminal device in the chatbot server device 2 as a sales record in association with date and time information. The evaluation information storage unit 123 also stores information obtained by aggregating the sales results based on the sales record as evaluation information. The evaluation and measurement unit 112 writes the information obtained by aggregating the sales results as the evaluation information to the evaluation information storage unit 123 by performing a process of aggregating the sales results on the basis of the sales record within the log information. Consequently, the search unit 132 can also output information of the chatbot server device 2 in an order based on the information obtained by aggregating the sales results.

According to the above-described configuration, in the present embodiment, the chatbot search system 1 can preferentially output information of the chatbot server device 2 having an excellent sales record as a search result.

Although embodiments and modified examples of the present invention have been described above in detail with reference to the drawings, specific configurations are not limited to the embodiments and other designs and the like may be included without departing from the spirit and scope of the present invention.

### INDUSTRIAL APPLICABILITY

For example, the present invention can be used in a search service on the Internet. However, the use range of the present invention is not limited to an exemplified range.

### REFERENCE SIGNS LIST

1 Chatbot search system
2 Chatbot server device
11 Chatbot information collection device (chatbot information collection unit, search interface device, search interface unit)
12 Storage device
13 Search server device
14 User interface server device
21 Knowledge base
22 Chat engine unit
23 User interface unit
24 Information storage unit
25 Information provision unit
31, 32 Terminal device
111 Traffic information collection unit
112 Evaluation and measurement unit
113 Chatbot field management unit
121 Log information storage unit
122 Content storage unit
123 Evaluation information storage unit
124 Field information storage unit
131 Condition input unit
133 Search result output unit
241 Log information storage unit
242 Field information storage unit
243 Content storage unit
311 Web browser unit
321 Application program execution unit

What is claimed is:

1. A chatbot search system comprising:
a chatbot information collection unit configured to collect log information recorded by associating exchange of a text with a terminal device in a chatbot server device with date and time information from the chatbot server device that provides a chat service by automatically generating a response text in accordance with a text transmitted from the terminal device of a user and transmitting the response text to the terminal device;
a log information storage unit configured to store the log information;
an evaluation information storage unit configured to store evaluation information of the chatbot server device;
an evaluation and measurement unit configured to generate the evaluation information of the chatbot server device on the basis of the log information and write the evaluation information to the evaluation information storage unit; and
a search unit configured to read the evaluation information of the chatbot server device matching a search condition from the evaluation information storage unit on the basis of the search condition that has been input and output information of the chatbot server device in an order based on the evaluation information.

2. The chatbot search system according to claim 1, wherein the evaluation and measurement unit evaluates reliability of the chatbot server device by analyzing a chat text included in the log information and writes the reliability as the evaluation information of the chatbot server device to the evaluation information storage unit.

3. The chatbot search system according to claim 2,
wherein the evaluation and measurement unit evaluates the reliability by incrementing the number of positive evaluation points and the number of negative evaluation points on the basis of the text and the response text, and
wherein the evaluation and measurement unit accumulates a learning shortage response example which is an example of a response sentence in advance when an amount of learning in the chatbot server device is insufficient and increments the number of negative evaluation points in relation to the chatbot server device when the text output by the chatbot server device corresponds to the learning shortage response example.

4. The chatbot search system according to claim 1, wherein the evaluation and measurement unit calculates the number of users per unit time for the chatbot server device on the basis of the log information and writes the number of users per unit time as the evaluation information of the chatbot server device to the evaluation information storage unit.

5. The chatbot search system according to claim 1, wherein the evaluation and measurement unit calculates average usage time of the user in the chatbot server device on the basis of the log information and writes the average usage time of the user as the evaluation information of the chatbot server device to the evaluation information storage unit.

6. The chatbot search system according to claim 1,
wherein the chatbot server device performs a process of performing machine learning based on content data in advance and automatically generating the response text in correspondence with the text transmitted from the terminal device of the user on the basis of a result of the machine learning,
wherein the chatbot information collection unit collects the content data from the chatbot server device, and
wherein the search unit selects the chatbot server device on the basis of a degree of matching between the content data collected by the chatbot information collection unit and the search condition and outputs a selection result.

7. The chatbot search system according to claim 1,
wherein the chatbot server device holds field information indicating a field of the chat service to be provided,
wherein the chatbot information collection unit collects the field information from the chatbot server device, and
wherein the search unit selects the chatbot server device on the basis of a degree of matching between the field information collected by the chatbot information collection unit and field information included in the search condition and outputs a selection result.

8. The chatbot search system according to any one of claim 1, further comprising a search interface unit configured to receive a search condition extracted from the text by a first chatbot server device from the first chatbot server device when the first chatbot server device provides the chat service to the terminal device, transfer the received search condition to the search unit, receive information of a second chatbot server device corresponding to the search condition from the search unit, and return the information of the second chatbot server device to the first chatbot server device,
wherein the search unit outputs the information of the second chatbot server device based on the search condition to the search interface unit when the search condition has been transferred from the search interface unit.

9. The chatbot search system according to claim 8, wherein the search unit outputs the information of the chatbot server device and the information of the second chatbot server device to the search interface unit for the terminal device to simultaneously access both the chatbot server device and the second chatbot server device.

10. The chatbot search system according to claim 1,
wherein the chatbot information collection unit collects the log information including information about sales results in the exchange of the text with the terminal device in the chatbot server device as a sales record in association with the date and time information,
wherein the evaluation information storage unit stores information obtained by aggregating the sales results based on the sales record as the evaluation information,
wherein the evaluation and measurement unit writes the information obtained by aggregating the sales results as the evaluation information to the evaluation information storage unit by performing a process of aggregating the sales results on the basis of the sales record within the log information, and
wherein the search unit outputs the information of the chatbot server device in an order based on the information obtained by aggregating the sales results.

11. A chatbot search method comprising the steps of:
collecting, by a chatbot information collection unit, log information recorded by associating exchange of a text with a terminal device in a chatbot server device with date and time information from the chatbot server device that provides a chat service by automatically generating a response text in accordance with a text transmitted from the terminal device of a user and transmitting the response text to the terminal device;
writing the log information to a log information storage unit;
generating, by an evaluation and measurement unit, evaluation information of the chatbot server device on the basis of the log information and writing the evaluation information to the evaluation information storage unit; and
reading, by a search unit, the evaluation information of the chatbot server device matching a search condition from an evaluation information storage unit on the basis of the search condition that has been input and outputting information of the chatbot server device in an order based on the evaluation information.

12. A program for causing a computer to execute the steps of:
collecting, by a chatbot information collection unit, log information recorded by associating exchange of a text with a terminal device in a chatbot server device with date and time information from the chatbot server device that provides a chat service by automatically generating a response text in accordance with a text transmitted from the terminal device of a user and transmitting the response text to the terminal device;
writing the log information to a log information storage unit;
generating, by an evaluation and measurement unit, evaluation information of the chatbot server device on the basis of the log information and writing the evaluation information to an evaluation information storage unit; and
reading, by a search unit, the evaluation information of the chatbot server device matching a search condition from the evaluation information storage unit on the basis of the search condition that has been input and outputting information of the chatbot server device in an order based on the evaluation information.
